(19) United States
(12) Patent Application Publication
(10) Pub. No.: US 2020/0278840 A1
(43) Pub. Date: Sep. 3, 2020

(54) MULTI-QUESTION MULTI-ANSWER CONFIGURATION

(71) Applicant: InvestCloud Inc, West Hollywood, CA (US)

(72) Inventors: John W. Wise, West Hollywood, CA (US); Julian C. Bowden, London (GB); Vicent Sos-Munoz, Beverly Hills, CA (US); Brett Heinz, Los Angeles, CA (US)

(73) Assignee: InvestCloud Inc, West Hollywood, CA (US)

(21) Appl. No.: 16/057,578

(22) Filed: Aug. 7, 2018

(51) Int. Cl. G06F 8/35; G06Q 40/06; G06F 3/0484

(52) U.S. Cl. CPC G06F 8/35; G06F 3/04845; G06Q 40/06

(57) ABSTRACT

A process generates, with a processor, a graphical user interface that displays a plurality of movable objects. A first subset of the plurality of movable objects corresponds to a plurality of questions. Further, a second subset of the plurality of movable objects corresponds to a plurality of answers. The process receives, with the processor at the graphical user interface, at least one input corresponding to at least one of the plurality of movable objects. The at least one input indicates a movement of at least one of the plurality of moveable objects from a first position to a second position in the graphical user interface. The process also automatically generates, with the processor without a manual input, code corresponding to a workflow based on the at least one input. The workflow corresponds to a conditional, ordered sequence that a computing device automatically processes to determine a corresponding financial model.

### BACKGROUND

### 1. Field

This disclosure generally relates to the field of computing systems. More particularly, the disclosure relates to software application code generation.

### 2. General Background

With recent developments in computing systems, financial technology (“Fintech”) platforms have allowed financial institutions/advisors to generate computerized financial models for end-users. Rather than having to rely solely on a human financial advisor, end-users may access a web portal to answer a linear-based series of questions that help the Fintech platform solely (e.g., via a robo-advisor), or in conjunction with a human financial advisor, develop a financial model that reflects the end-user's financial goals. The web portal solely, or in conjunction with the human financial advisor, may then generate a recommended portfolio, or other form of asset allocation, for the end-user.

Yet, such Fintech platforms are typically quite resource-intensive to build. As a result, a programmer may only build one version of the linear-based series of questions and answers so that the Fintech platform may be scaled for use by multiple financial institutions/advisors.

But what may be an apropos set of questions and answers for the financial modeling system of one financial institution/advisor to generate a recommended portfolio may be less pertinent to another financial institution/advisor. For example, a financial model developed by a financial institution/advisor may rely on certain data that is not provided by a “one-size-fits-all” set of questions and answers; as a result, the portfolio recommended by that financial institution/advisor may be inconsistent with the financial model that would have been generated with all of the pertinent data. Therefore, Fintech platforms are often too inflexible to effectively generate end-user recommendations based on varying parameters.

### SUMMARY

In one aspect of the disclosure, a computer program product is provided. The computer program product comprises a non-transitory computer useable storage device having a computer readable program. The computer readable program when executed on a computer causes the computer to generate, with a processor, a graphical user interface that displays a plurality of movable objects. A first subset of the plurality of movable objects corresponds to a plurality of questions. Further, a second subset of the plurality of movable objects corresponds to a plurality of answers. In addition, the computer is caused to receive, with the processor at the graphical user interface, at least one input corresponding to at least one of the plurality of movable objects. The at least one input indicates a movement of at least one of the plurality of moveable objects from a first position to a second position in the graphical user interface. The computer is also caused to automatically generate, with the processor without a manual input, code corresponding to a workflow based on the at least one input. The workflow corresponds to a conditional, ordered sequence that a computing device automatically processes to determine a corresponding financial model. A system and/or apparatus may also perform the process executed by the computer readable program.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a previous a manual, linear-based question and answer configuration to generate a portfolio recommendation based on a financial model.

FIG. 2 illustrates a hierarchical, customizable workflow that is generated by a multi-question multi-answer (“MQMA”) configuration.

FIG. 3A illustrates a display device that displays an MQMA graphical user interface (“GUI”) configuration.

FIG. 3B illustrates an example of the user adding various conditional redirection indicia to indicate the logic flow of the customizable workflow.

FIG. 4 illustrates an MQMA system that automatically generates the customizable workflow illustrated in FIG. 2 for correlation with a financial model to generate a portfolio recommendation via a web portal.

FIG. 5A illustrates an example of a screenshot of GUI for a first predetermined category directed toward identification of a user.

FIG. 5B illustrates a screenshot of a GUI that assesses a risk profile via a customer questionnaire regarding investment statements.

FIG. 5C illustrates a screenshot of a GUI that assesses retirement planning for a customer.

FIG. 5D illustrates a screenshot of a GUI that provides a specific risk scenario to help gauge the level of risk adversity willing to be undertaken by the customer.

FIG. 5E illustrates a screenshot of a GUI that provides specific investments to the customer to help gauge the level of risk adversity willing to be undertaken by the customer.

FIG. 5F illustrates a screenshot that provides possible guiding principles for portfolio generation.

FIG. 5G illustrates a GUI that displays one potential financial model.

FIG. 5H illustrates a GUI that displays another potential financial model.

FIG. 6 illustrates the internal components of the MQMA system illustrated in FIG. 3.

FIG. 7 illustrates a process that may be utilized by the MQMA generator illustrated in FIGS. 4 and 6.

### DETAILED DESCRIPTION

An MQMA configuration is provided to automatically generate a hierarchy of customizable questions and answers for a Fintech platform. The MQMA configuration provides a financial institution/advisor with a GUI to generate a conditional workflow for a set of questions and answers. The conditional workflow allows for conditional redirection to subsequent questions based on answers to previous questions. For example, the MQMA configuration allows the financial institution/advisor to select, or drag-and-drop, questions, potential answers to those questions, and flow direction to other questions based on those answers, whereby such selection occurs via the GUI. In other words, the financial institution/advisor is able to customize the arrangement of a workflow, via the MQMA configuration, for the question and answer portion of an automated financial recommendation system.

Further, the MQMA configuration allows for the set of questions and answers to be inputted into a financial modelling engine that generates a financial model based on the set of questions and answers. By way of contrast with previous configurations that allowed for mismatching of financial models with deficient sets of data obtained from a linear-based question and answer system, the MQMA configuration generates customizable workflows that align, or at least substantially align, with the financial models generated by the financial modelling engine. In one embodiment, the MQMA configuration uses the inputs (e.g., graphical object positioning, text, etc.) for question and answer objects received through the GUI. The MQMA configuration generates code (e.g., a computer program) based on the graphical arrangement of the workflow. Accordingly, the MQMA GUI allows a user (e.g., financial institution/advisor), who may not be familiar with computer programming, to automatically build a computer program that generates a customizable question and answer workflow. In addition, the MQMA GUI may also allow the user to automatically correlate the set of questions and answers with a financial model by assigning weights to various questions and scores to answers to those questions.

In one embodiment, the graphical objects of the MQMA configuration are pre-determined. In other words, the user (e.g., financial institution/advisor) may move objects corresponding to pre-defined questions in a graphical manner via the GUI to correlate with objects corresponding to pre-defined answers. In another embodiment, the graphical objects of the MQMA configuration are defined by the user (e.g., financial institution/advisor).

Further, in yet another embodiment, the MQMA configuration is integrated with, or in operable communication with, an artificial intelligence (“AI”) system that utilizes machine learning to provide recommendations for a customizable workflow. For instance, the AI system may determine that the particular user (e.g., financial institution/advisor) regularly selects particular types of questions and/or particular types of answers. Accordingly, the AI system may recommend certain objects for placement within the customizable workflow during the user's composition of the workflow via the MQMA GUI.

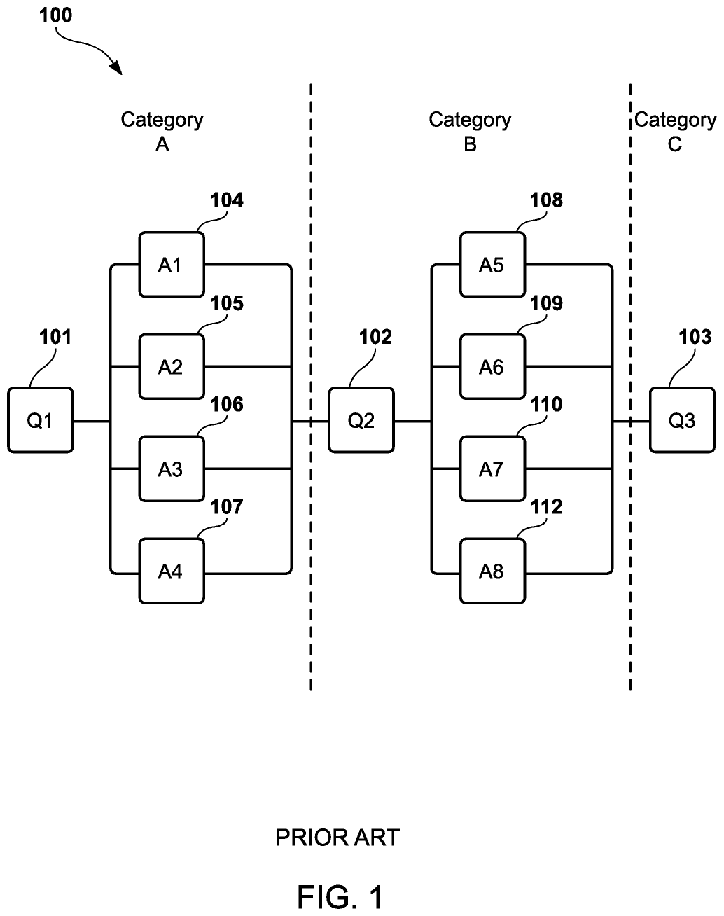

FIG. 1 illustrates a previous a manual, linear-based question and answer configuration 100 to generate a portfolio recommendation based on a financial model. A user (e.g., financial advisor/institution) would typically procure the services of a programmer to hard-code a particular linear set of questions and answers that would be utilized to obtain data for financial model selection. In other words, the user would simply request a particular workflow, and the programmer would manually generate the code necessary for that workflow. The programmer would then provide the resulting layout to the user for incorporation into a web portal of the user so that customers of the user could access the resulting layout.

Yet, the aforementioned configuration provided a fixed, rigid solution that led to scalability and customization problems. For instance, if a user wanted to modify the workflow, the user would have to request that the programmer manually change the hard-coded program associated with the workflow layout because the user did not have any feasible means of self-customizing the layout.

In addition, if the user wanted to generate somewhat different workflows for different customers, the user would typically have to request that the programmer generate parallel-running programs for each layout—a resource-intensive process. Moreover, manually coding parallel programs for a customer with financial models that may regularly change is subject to being error-prone.

As an example, the manual, linear-based question and answer configuration 100 has three questions 101, 102, and 103, each corresponding to a different informational category (e.g., identity of user, regulatory compliance, and risk tolerance). Each question typically corresponds to a screen of a layout that allows for customer input for the user to learn more about the customer for financial model selection. For example, the first question 101 may be associated with four hard-coded answers 104, 105, 106, and 107. In a typical configuration, a web portal will generate a next screen for an additional category irrespective of the answers 104, 105, 106, or 107; data is gathered for financial model selection, but the screens displayed to the customer are the same regardless of the answers. A similar logic flow is illustrated for the second question 102, the answers 106-111, and a next screen based on the third question 103. Accordingly, the manual, linear-based question and answer configuration 100 is a fixed layout that does not allow for customization by the user without manual recoding by the programmer, or by a user with extensive programming knowledge.

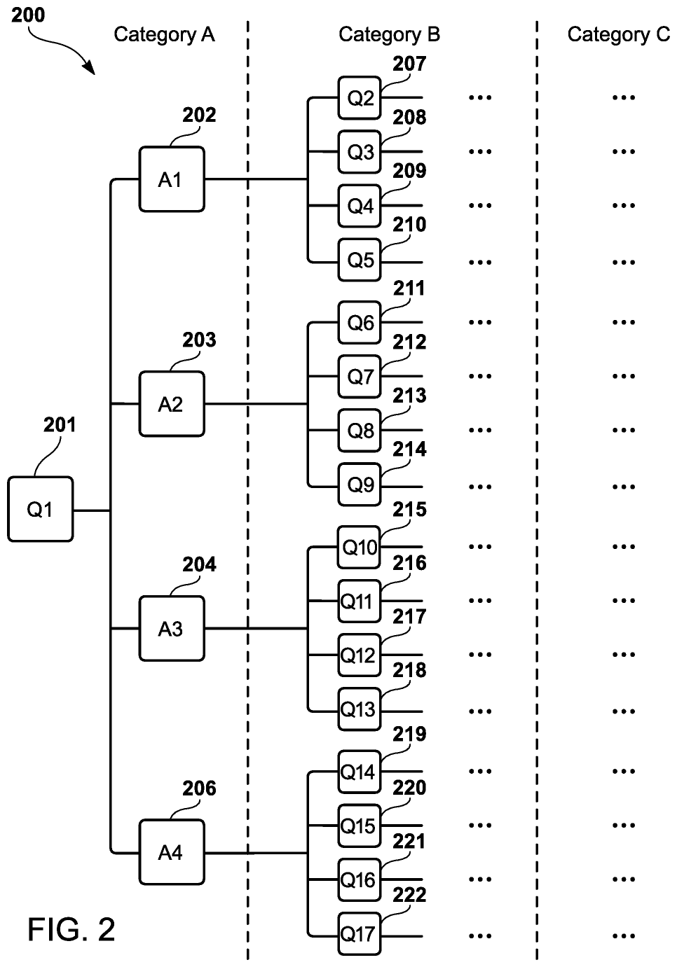

FIG. 2 illustrates a hierarchical, customizable workflow 200 that is generated by an MQMA configuration. Rather than requiring a substantial multitude of programs to accommodate varying users (e.g., financial advisor/institution) and/or varying customers for an individual user, the customizable workflow 200 allows the user to be in control of customizing a workflow without multiple parallel programs, as illustrated in FIG. 1. Even if the user has little or no programming knowledge, the customizable workflow 200 may automatically be generated for the user.

As an example, the customizable workflow 200 may include a first question 201, which was included by the user. Further, the customizable workflow 200 may include various answers 202-206, selected by the user, to the first question; each of those answers 202-206 may then have corresponding questions in a different, or possibly the same, informational category (e.g., questions 207-210 corresponding to answer 202, questions 211-214 corresponding to answer 203, questions 215-218 corresponding to answer 204, and questions 219-222 corresponding to answer 204).

Accordingly, a user may modify the customizable workflow 200 by arranging the various question and answer nodes. The user may determine that some pages should not be viewed at all by a user based on previous answers to questions.

As illustrated, the customizable workflow 200 is implemented in a hierarchical configuration in which different layers are reached or not reached based upon various conditional redirection criteria being met, or not met, at nodes at a previous level. For example, a tree data structure (e.g., binary tree) may be utilized to store the customizable workflow 200. As a result, a computing device generating the customizable workflow 200 is able to search nodes for display at a web portal, which generates a financial model, faster than the manual, linear-based question and answer configuration 100 illustrated in FIG. 1. Accordingly, the customizable workflow 200 improves the functioning of a computer.

Further, the customizable workflow 200 provides additional flexibility not available with the manual, linear-based question and answer configuration 100 illustrated in FIG. 1. In contrast to a fixed, rigid layout that often requires a new computer program, and additional computing and manual resources, for each new user variation, the customizable workflow 200 provides the user with the flexibility of using a single program, or substantially less programs than the manual, linear-based question and answer configuration 100, to automatically generate questions and answers utilized for financial model selection at a web portal. Therefore, the customizable workflow 200 improves the functioning of a computer.

In addition, the customizable workflow 200 reduces the memory requirements of a computer. In contrast with having to store a multitude of programs for each variation requested by a customer, which often results in code duplication and additional computing resources, the customizable workflow 200 is generated with a single program, or possibly a few programs. The data structure storing the hierarchical configuration avoids storing duplicative code and date because a single data structure may be traversed based on various conditions being met or not met. Accordingly, the customizable workflow 200 utilizes smaller memory requirements than previous configurations. Therefore, the customizable workflow 200 improves the functioning of a computer for this additional reason.

Although a tree-based data structure is illustrated in FIG. 2, various other data structures may be utilized in order to store and traverse conditional redirection criterial for a set of questions and answers. For example, a daisy chain configuration may be utilized such that a chain of questions and answers are linked according to a daisy chain format.

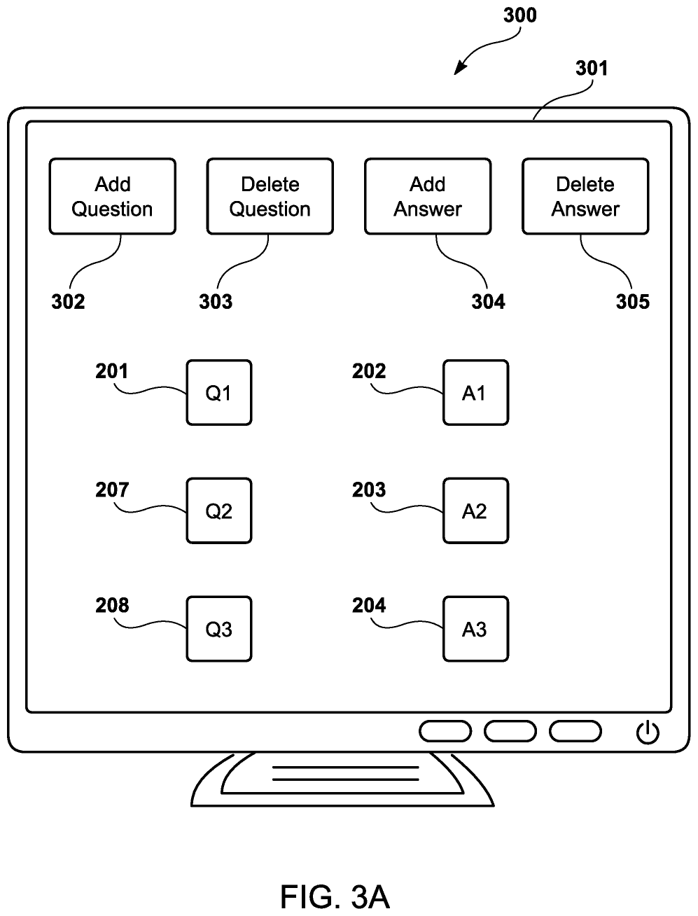

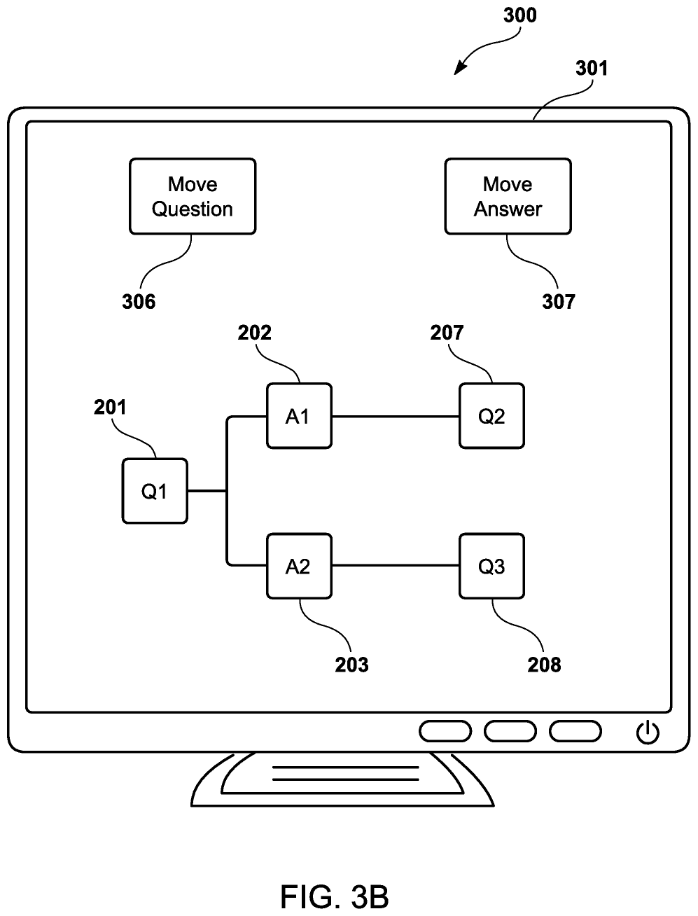

FIGS. 3A and 3B illustrate an example of an MQMA GUI that may be utilized by a financial institution/advisor to automatically generate a customizable workflow for a client device. FIG. 3A illustrates a display device 300 (e.g., display screen, monitor screen, etc.) that displays an MQMA GUI 301. As an example, the MQMA GUI 300 may allows the user to select from various input indicia 302-305 (e.g., buttons, touch screen swipes, etc.) to provide various commands with respect to arranging various questions and answers. For instance, a plurality of pre-determined question buttons (e.g., questions 201, 207, and 208) and a plurality of pre-determined answer buttons (e.g., answers 202 and 203) may be displayed for possible arrangement by the user. For instance, the user may provide various forms of input (e.g., drag-and-drop, gestures, etc.) to indicate a possible arrangement or the pre-determined question and answer buttons. The user may also perform various operations such as adding/deleting question and answer buttons via the input indicia 302-305.

Further, FIG. 3B illustrates an example of the user adding various conditional redirection indicia (e.g., connectors, arrows, etc.) to indicate the logic flow of the customizable workflow 200 (FIG. 2). The user may perform drag-and-drop operations, gestures, and/or selection of input indicia (e.g., buttons 306 and 307) to move questions and/or answers.

As an alternative to utilization of pre-determined questions and answers, the customizable workflow 200 may allow a user to customize not only the arrangement of the questions and answers, but also the content of the questions and answers themselves. For example, the GUI 301 may also have an input indicium that allows a user to compose a new question and/or answer. The user may then customize the arrangement of the new question and/or answer with respect to the previously established questions and/or answers.

The GUI 301 allows a user that has little or no programming experience to automatically generate, and customize, a workflow for selection of a financial model. Each movement of a particular graphical object may be associated with an automatic code generation command to generate code for the arrangement of questions and answers in a workflow layout based on positioning of graphical objects. As a result, a user can generate and modify the code for a workflow based on the graphical positioning of objects.

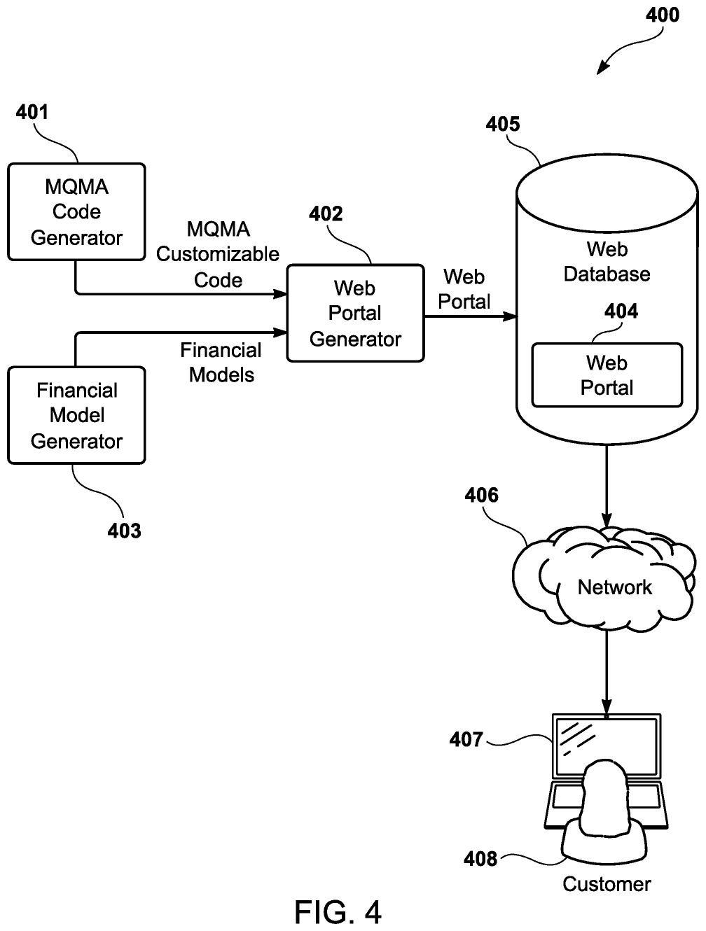

FIG. 4 illustrates an MQMA system 400 that automatically generates the customizable workflow 200 illustrated in FIG. 2 for correlation with a financial model to generate a portfolio recommendation via a web portal. The MQMA system 400 includes an MQMA code generator 401 that automatically generates MQMA code based on graphical positioning of objects, or other non-coding configuration.

In one embodiment, the MQMA system 400 generates the MQMA customizable workflow 200 illustrated in FIG. 2 via an MQMA code generator 401, which then sends the MQMA customizable workflow 200 to a web portal generator 402. In an alternative embodiment, the MQMA code generator 401 sends the MQMA customizable code to the web portal generator 402, which then executes the MQMA customizable code to automatically generate the customizable workflow 200.

Further, a financial model generator 403 may generate one or more financial models. The financial model generator 403 may then sends the one or more financial models to the web portal generator 402, which associates an optimal financial model with answers to the questions determined by the customizable workflow 200 (FIG. 2). For example, the web portal generator 402 may associate a score with each answer in the customizable workflow 200. The web portal generator 402 may then select a financial model based on the most optimal score.

Although scoring is described herein, the web portal generator 402 may generate a web portal without any type of scoring. Further, scoring may be used with respect to models other than financial models (e.g., vacation destination models, car rental models, etc.). In other words, the web portal generator 402 may be used to associate an optimal model, other than that of a financial model, with answers to the questions determined by the customizable workflow 200 (FIG. 2). Accordingly, the MQMA approach described herein may be utilized for a variety of different types of models that assist a user in performing a selection of a product and/or service.

In another embodiment, the customizable workflow 200 may be linked with a current indicium and/or a not current indicium; accordingly, if the user traverses the customizable workflow 200 a subsequent time, the original workflow, which was previously stored, is linked to the new workflow. Further, images may be linked to the questions in the customizable workflow 200. Additionally, the questions and answers in the customizable workflow 200 may appear in a human spoken language that matches the needs of the user. For example, the MQMA code generator 401 may generate code that, when executed by a processor, translates a question and/or answer from a first human spoken language to a second human spoken language.

After the web portal is generated, the web portal generator 402 may send the web portal 404 to a web database 405 for storage. A computing device 407 (e.g., personal computer, laptop computer, mobile device, smartphone, smart wearable, etc.) operated by a customer 408 of the user may then access the generated web portal 404 via a network (e.g., wireless or wired). The customer of the user may then answer the questions and answers, as selected by the customizable workflow 200, appearing on various screens of the web portal (e.g., via a plug-in or the web portal itself). Upon completion of answering those questions, the customer may then be provided with a financial model and a recommended portfolio determined based upon that financial model.

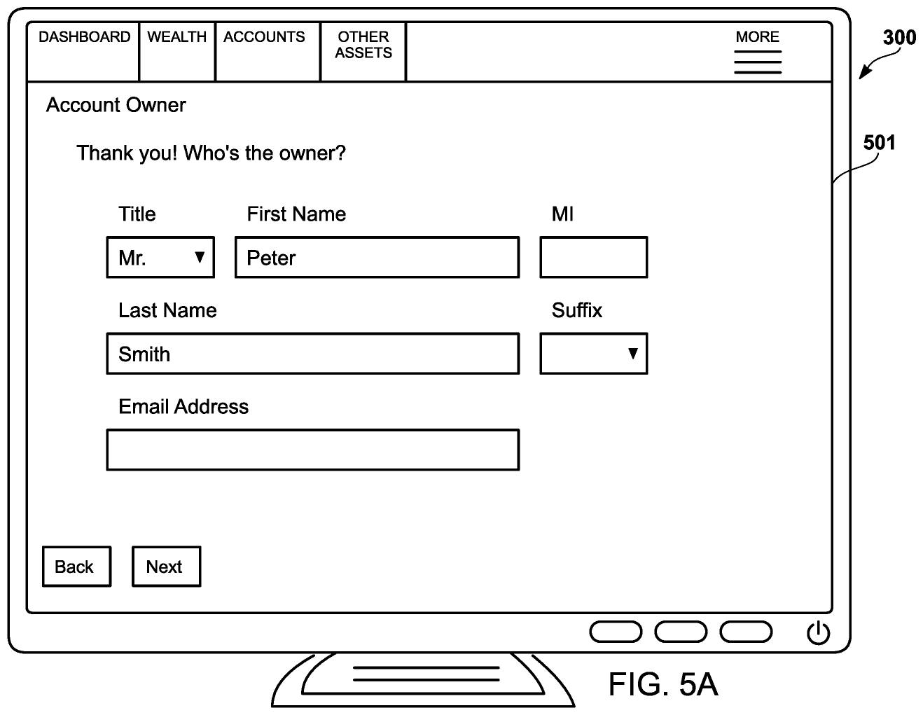

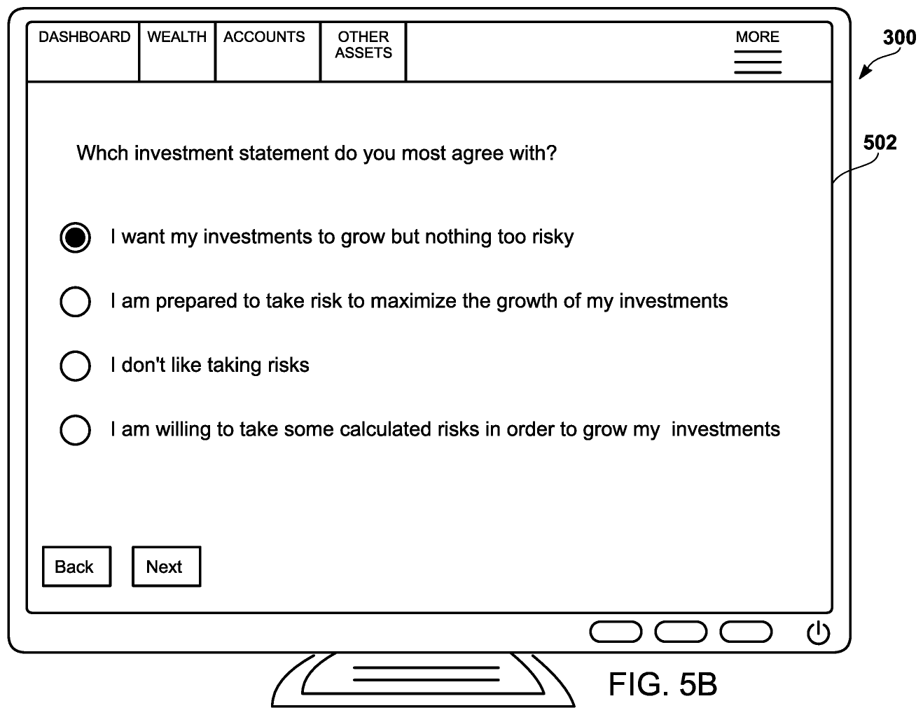

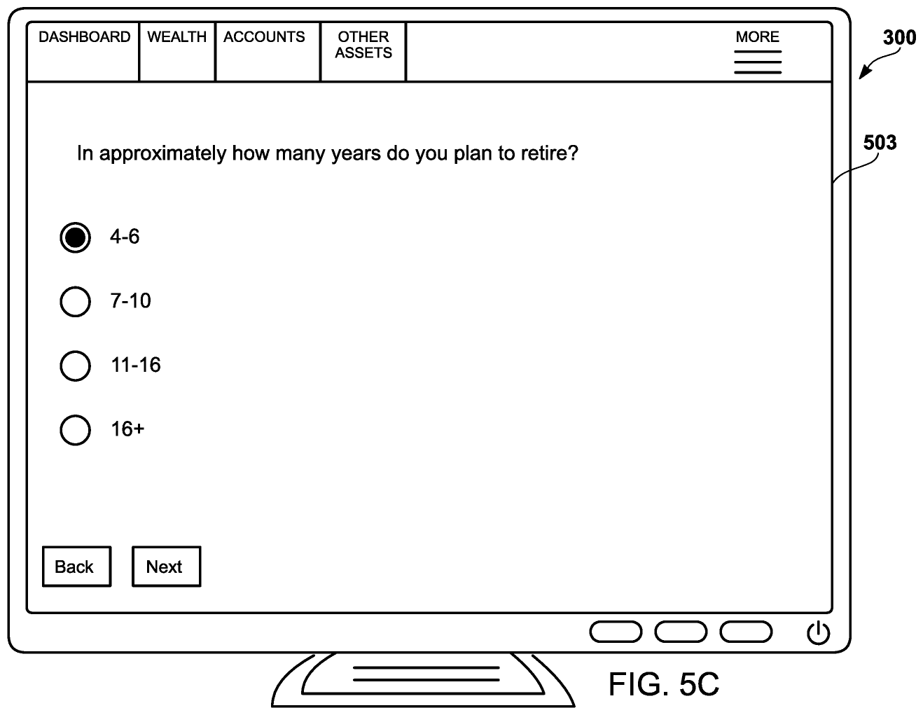

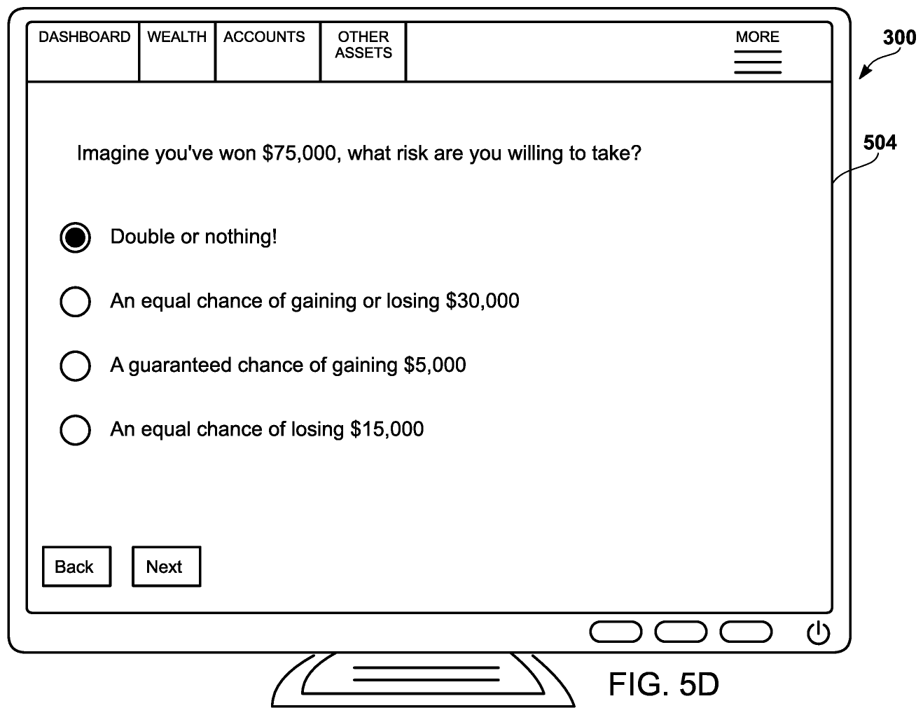

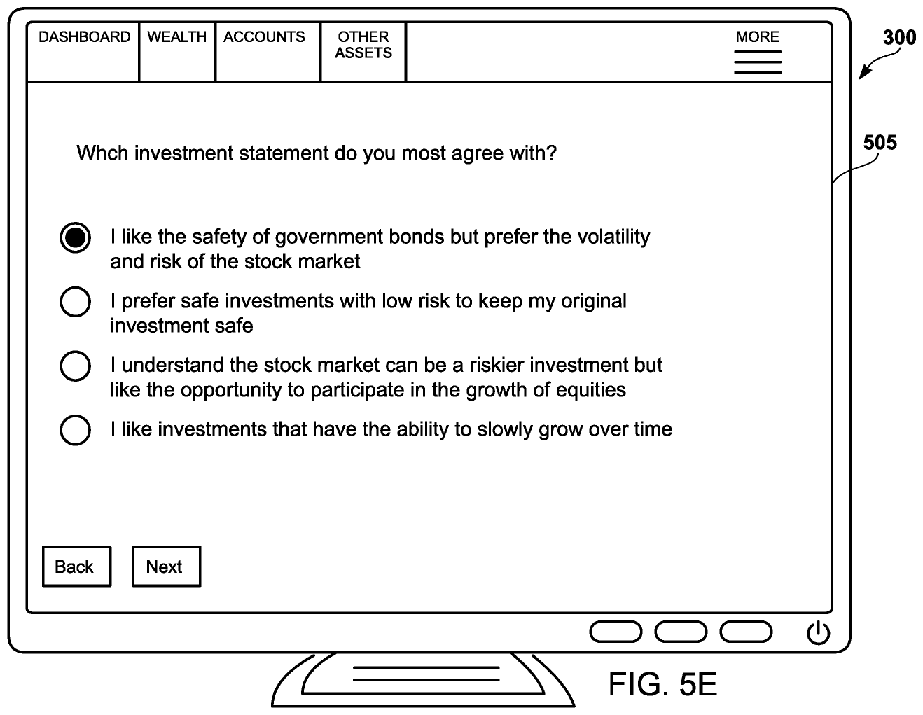

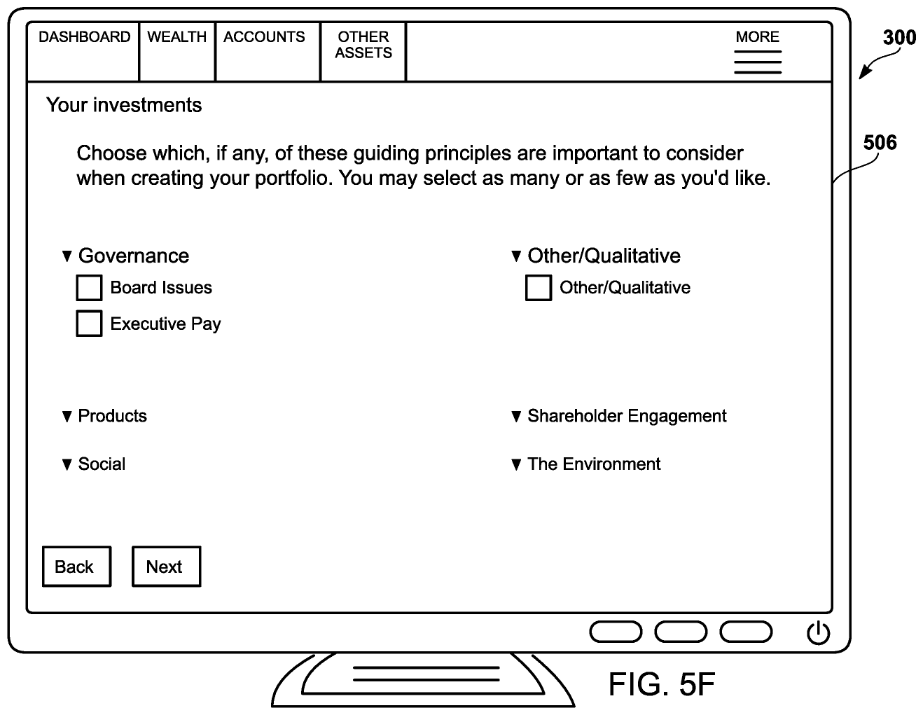

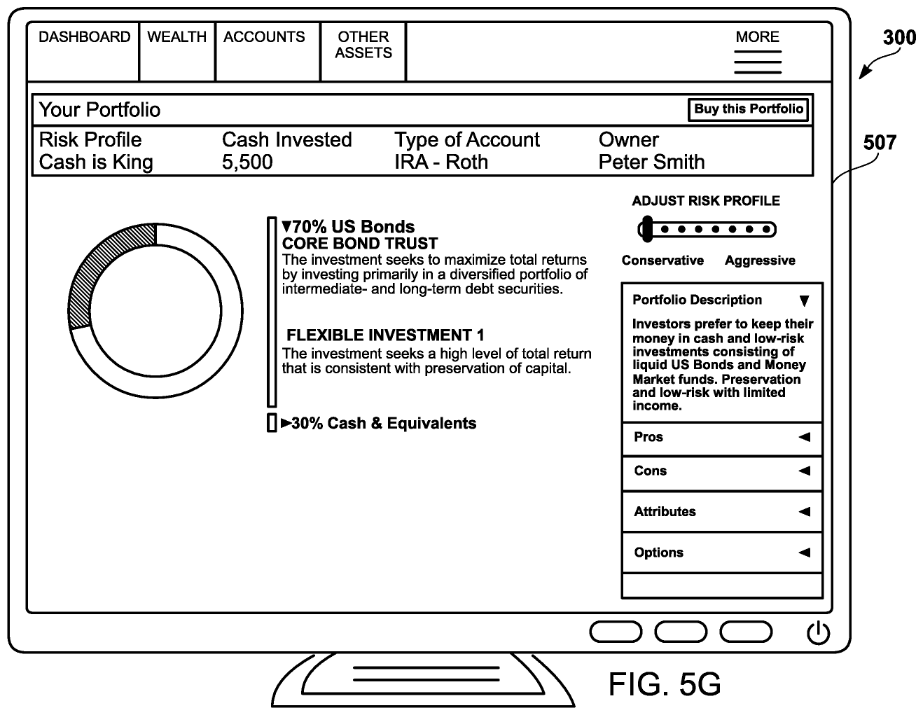

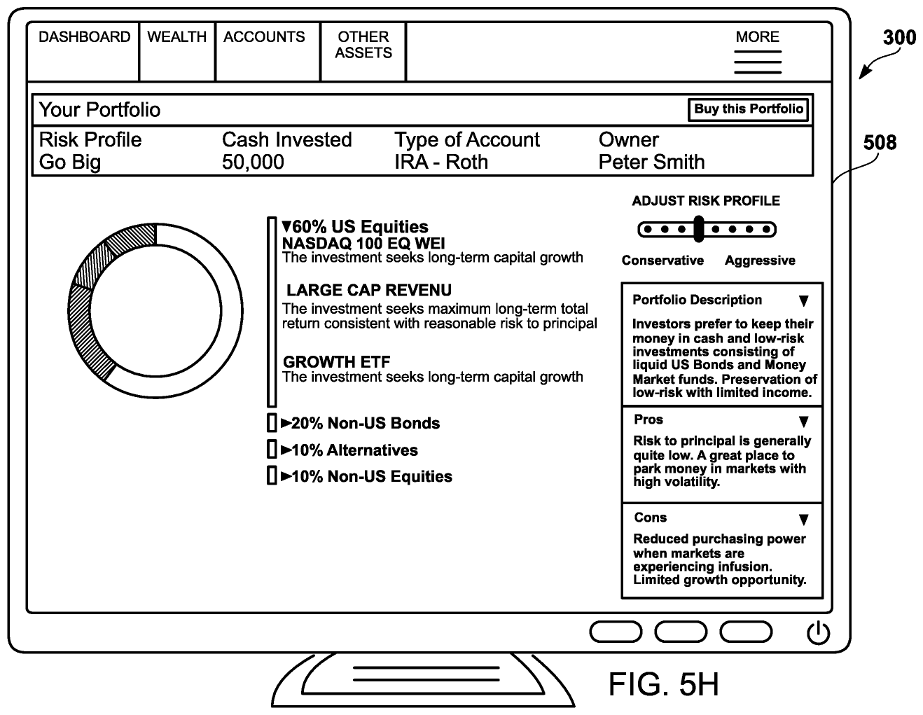

FIGS. 5A-5H illustrate example screenshots of screens displayed to a customer of the user as a result of the customizable workflow 200 illustrated in FIG. 2. For example, FIG. 5A illustrates an example of a screenshot of GUI 501 for a first predetermined category directed toward identification of a user. As illustrated, various fields receive input information regarding the identity of the user. Although only a few data fields are illustrated in FIG. 5A, various additional fields and/or additional screens may be displayed to the customer so that the user (e.g., financial institution/financial advisor) may obtain necessary data to generate a financial model for the customer; such data may be for account creation (e.g., “customer onboarding”), know-your-customer (“KYC”) regulations, or a variety of other internal and/or external compliance purposes.

After establishing the identity of the customer, the user (e.g., financial institution/advisor) may proceed to another predetermined category to assess the risk tolerance of the customer. For example, FIG. 5B illustrates a screenshot of a GUI 502 that assesses a risk profile via a customer questionnaire regarding investment statements. As another example, FIG. 5C illustrates a screenshot of a GUI 503 that assesses retirement planning for a customer. As yet another example, FIG. 5D illustrates a screenshot of a GUI 504 that provides a specific risk scenario to help gauge the level of risk adversity willing to be undertaken by the customer. As another example, FIG. 5E illustrates a screenshot of a GUI 505 that provides specific investments to the customer to help gauge the level of risk adversity willing to be undertaken by the customer. Finally, as another example, FIG. 5F illustrates a screenshot 506 that provides possible guiding principles for portfolio generation.

After the questions in FIGS. 5A-5F are answered by the customer, the financial model may be generated based upon the inputted data. For example, FIG. 5G illustrates a GUI 507 that displays one potential financial model. As another example, FIG. 5H illustrates a GUI 508 that displays another potential financial model.

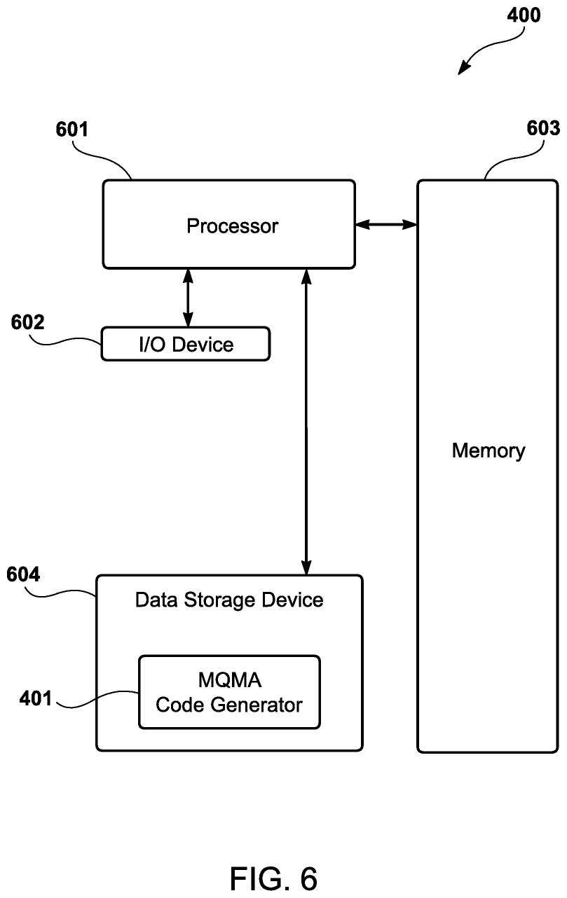

FIG. 6 illustrates the internal components of the MQMA system 400 illustrated in FIG. 4. In one embodiment, the MQMA system 400 is implemented utilizing a specialized computer or any other hardware equivalents. The MQMA system 400 has a processor 601, a memory 603 (e.g., random access memory and/or read only memory), MQMA code generator 401, a data storage device 604 that stores the MQMA code generator 401, and various input/output (“I/O”) devices 602 (e.g., audio/video outputs, audio/video inputs, a receiver, a transmitter, a speaker, a display, an image capturing sensor, a clock, an output port, a user input device, etc.).

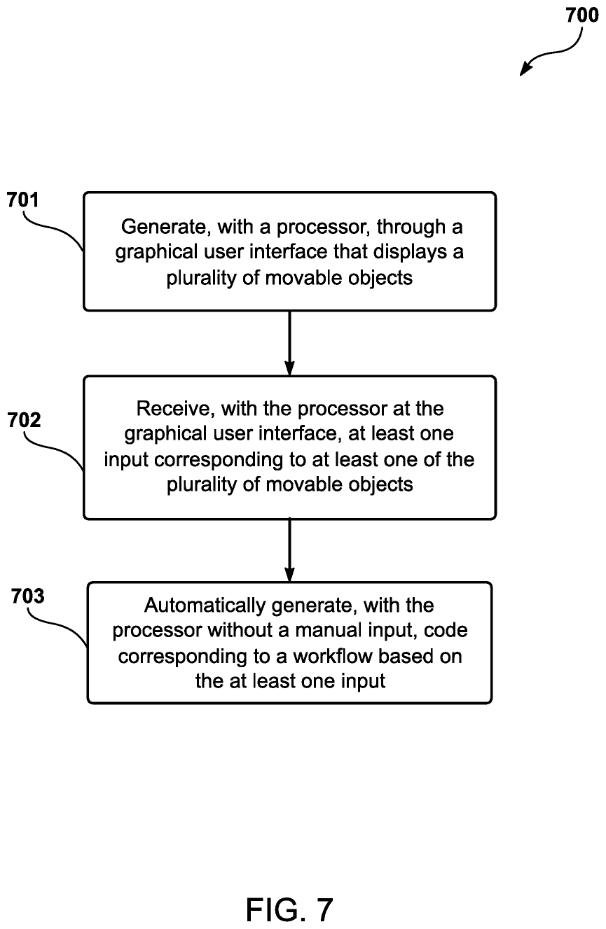

FIG. 7 illustrates a process 700 that may be utilized by the MQMA generator 401 illustrated in FIGS. 4 and 6. At a process block 701, the process 700 generates, with the processor 601, the GUI 301d (FIG. 3) that displays a plurality of movable objects. A first subset of the plurality of movable objects corresponds to a plurality of questions. Further, a second subset of the plurality of movable objects corresponds to a plurality of answers. In addition, at a process block 702, the process 700 receives, with the processor 610 at the GUI 301, at least one input corresponding to at least one of the plurality of movable objects. The at least one input indicates a movement of at least one of the plurality of moveable objects from a first position to a second position in the GUI 301. Further, at a process block 703, the process 700 automatically generates, with the processor 601 without a manual input, code corresponding to a workflow based on the at least one input. The workflow corresponds to a conditional, ordered sequence that a computing device automatically processes to determine a corresponding financial model.

Although the processes described herein have been exemplified via a web portal, the process may be implemented via other types of software applications. For example, an application executed by a mobile computing device (e.g., smartphone, tablet device, smartwatch, smart wearable, etc.) may implement the aforementioned processes.

It is understood that the processes, systems, apparatuses, and computer program products described herein may also be applied in other types of processes, systems, apparatuses, and computer program products. Those skilled in the art will appreciate that the various adaptations and modifications of the embodiments of the processes, systems, apparatuses, and computer program products described herein may be configured without departing from the scope and spirit of the present processes and systems. Therefore, it is to be understood that, within the scope of the appended claims, the present processes, systems, apparatuses, and computer program products may be practiced other than as specifically described herein.

1. A computer program product comprising a non-transitory computer useable storage device having a computer readable program, wherein the computer readable program when executed on a computer causes the computer to:
generate, with a processor, a graphical user interface that displays a plurality of movable objects, a first subset of the plurality of movable objects corresponding to a plurality of questions, a second subset of the plurality of movable objects corresponding to a plurality of answers, each of the movable objects in the first subset corresponding to a distinct question in the plurality of questions, each of the movable objects in the second subset corresponding to a distinct answer in the plurality of answers;
receive, with the processor at the graphical user interface, at least one input corresponding to at least one of the plurality of movable objects, the at least one input indicating a movement of at least one of the plurality of movable objects from a first position to a second position in the graphical user interface; and
automatically generate, with the processor without a manual input, code corresponding to a workflow based on the at least one input, the workflow corresponding to a conditional, ordered sequence that a computing device automatically processes to determine a corresponding financial model.

2. The computer program product of claim 1, wherein the conditional, ordered sequence is a hierarchical configuration.

3. The computer program product of claim 2, wherein the conditional, ordered sequenced is stored in a data structure that provides traversal of the hierarchical configuration.

4. The computer program product of claim 3, wherein the computing device searches through the hierarchical configuration by traversing the data structure.

5. The computer program product of claim 1, wherein the at least one of the plurality of movable objects is a predetermined object that is generated prior to said receiving of said at least one input.

6. The computer program product of claim 1, wherein the at least one of the plurality of movable objects is generated during said receiving of said at least one user input.

7. The computer program product of claim 2, wherein the hierarchical configuration stores a first portion of the first subset according to a first predetermined category and stores a first portion of the second subsect according to the first predetermined category.

8. The computer program product of claim 7, wherein the first predetermined category is a user identification category.

9. The computer program product of claim 7, wherein the hierarchical configuration further stores a second portion of the first subset according to a second predetermined category and stores a second portion of the second subsect according to the second predetermined category.

10. The computer program product of claim 9, wherein the second predetermined category is a user risk.

11. The computer program product of claim 9, wherein the hierarchical configuration further stores a third portion of the first subset according to a third predetermined category and stores a third portion of the second subsect according to the third predetermined category.

12. The computer program product of claim 11, wherein the third predetermined category is a user risk tolerance level.

13. A system comprising:
a processor that generates a graphical user interface that displays a plurality of movable objects, receives, at the graphical user interface, at least one input corresponding to at least one of the plurality of movable objects, and automatically generates, without a manual input, code corresponding to a workflow based on at least one input, a first subset of the plurality of movable objects corresponding to a plurality of questions, a second subset of the plurality of movable objects corresponding to a plurality of answers, each of the movable objects in the first subset corresponding to a distinct question in the plurality of questions, each of the movable objects in the second subset corresponding to a distinct answer in the plurality of answers, the at least one input indicating a movement of at least one of the plurality of movable objects from a first position to a second position in the graphical user interface, the workflow corresponding to a conditional, ordered sequence that a computing device automatically processes to determine a corresponding financial model.

14. The system of claim 13, wherein the conditional, ordered sequence is a hierarchical configuration.

15. The system of claim 14, wherein the conditional, ordered sequenced is stored in a data structure that provides traversal of the hierarchical configuration.

16. The system of claim 15, wherein the computing device searches through the hierarchical configuration by traversing the data structure.

17. The system of claim 13, wherein the at least one of the plurality of movable objects is a predetermined object that is generated prior to said receiving of said at least one input.

18. The system of claim 13, wherein the at least one of the plurality of movable objects is generated during said receiving of said at least one user input.

19. The system of claim 13, wherein the code is a plug-in to a web portal that provides workflow customization for the financial model.

20. The computer program product of claim 13, wherein the code corresponds to a web portal that provides workflow customization for the financial model.
